(19) United States
(12) Patent Application Publication
(10) Pub. No.: US 2025/0054673 A1
(43) Pub. Date: Feb. 13, 2025

(54) INDUCTOR

(71) Applicant: LG INNOTEK CO., LTD., Seoul (KR)

(72) Inventors: In Seong SOHN, Seoul (KR); Ji Chang RYU, Seoul (KR); Seok BAE, Seoul (KR)

(21) Appl. No.: 18/722,372

(22) PCT Filed: Nov. 25, 2022
(86) PCT No.: PCT/KR2022/018825

§ 371 Date: Jun. 20, 2024

(30) Foreign Application Priority Data
Dec. 20, 2021 (KR) 10-2021-0182729

(51) Int. Cl. H01F 17/00; H01F 17/04

(52) U.S. Cl. CPC H01F 17/0013; H01F 17/0033; H01F 17/04; H01F 2017/002; H01F 2017/0073

(57) ABSTRACT

Disclosed is an inductor including a core unit including an inner leg and an outer leg and a coil unit including a coil disposed spirally around the inner leg and a coil substrate on which the coil is disposed, wherein the coil has a width gradually increasing from the inner leg to the outer leg in a horizontal direction between the inner leg and the outer leg.

### TECHNICAL FIELD

Embodiments relate to an inductor.

### BACKGROUND

In accordance with the trend of slimming of electronic products, a coil constituting an inductor has become popularized in the form of a printed circuit board (PCB) while sharing a middle leg of a magnetic core.

The coil of the inductor has a conductive pattern with a plurality of turns disposed on one surface or opposite surfaces of the printed circuit board, and the conductive pattern has a structure that spirally wraps around the middle leg of the magnetic core.

DC-bias is a factor for evaluating the main performance of the inductor, and in order to increase DC-bias, the inductance must be decreased or the size of a gap between upper and lower cores of the magnetic core must be increased.

Since inductance decreases with increasing gap amount, increasing the DC-bias of the inductor requires increasing the gap amount in a structure with high inductance.

In order to form a structure with high inductance, the number of turns of the conductive pattern must be increased, or the area of the middle leg of the magnetic core must be increased. However, this increases the area of the inductor, and therefore improvement to the inductor is needed.

### SUMMARY

An embodiment provides an inductor with increased inductance in the same area.

Another embodiment provides an inductor capable of controlling the width of the outermost coil pattern, which has great resistance, to reduce overall resistance, thereby minimizing heat generation.

Embodiments are not limited to those mentioned above, and other unmentioned embodiments will be apparent to those skilled in the art from the following description.

An inductor according to an embodiment includes a core unit including an inner leg and an outer leg and a coil unit including a coil disposed spirally around the inner leg and a coil substrate on which the coil is disposed, wherein the coil has a width gradually increasing from the inner leg to the outer leg in a horizontal direction between the inner leg and the outer leg.

The coil may include a plurality of overlapping coil patterns extending in a first direction, which is one component of the horizontal direction, passing between the inner leg and the outer leg, and overlapping the core unit in a vertical direction, and a plurality of non-overlapping coil patterns extending in a second direction, which is another component of the horizontal direction and intersects the first direction, and not overlapping the core unit in the vertical direction, the plurality of non-overlapping coil patterns may include a bent portion bent from the first direction to the second direction, and the bent portion may include a width variation portion where the width of the plurality of non-overlapping coil patterns is varied.

The range of the width of each of the plurality of non-overlapping coil patterns increasing in the horizontal direction may be 5% to 15%.

The core unit may include an upper core unit and a lower core unit opposite each other in the vertical direction, the upper core unit may include an upper inner leg portion and an upper outer leg portion protruding toward the lower core unit, the upper inner leg portion and the upper outer leg portion being spaced apart from each other in the second direction, and the lower core unit may include a lower inner leg portion and a lower outer leg portion protruding toward the upper inner leg portion and the upper outer leg portion, respectively, the lower inner leg portion and the lower outer leg portion being opposite each other and spaced apart from each other in the second direction.

The upper outer leg portion may include a first upper outer leg portion and a second upper outer leg portion disposed at an edge of the upper core unit, the upper inner leg portion may include an upper middle leg portion disposed in the middle between the first upper outer leg portion and the second upper outer leg portion, the lower outer leg portion may include a first lower outer leg portion and a second lower outer leg portion disposed at an edge of the lower core unit, the first lower outer leg portion and the second lower outer leg portion being opposite the first upper outer leg portion and the second upper outer leg portion, respectively, in the vertical direction, and the lower inner leg portion may include a lower middle leg portion disposed in the middle between the first lower outer leg portion and the second lower outer leg portion, the lower middle leg portion being opposite the upper middle leg portion in the vertical direction.

The inductor may include at least one of a first gap formed between the upper inner leg portion and the lower inner leg portion and a second gap formed between the upper outer leg portion and the lower outer leg portion.

The distance of at least one of the first gap and the second gap in the vertical direction may be 10 um to 700 mm.

The coil may include an upper coil disposed on an upper surface of the coil substrate, the upper coil spirally disposed around the upper inner leg portion, and a lower coil disposed on a lower surface of the coil substrate, the lower coil being spirally disposed around the lower inner leg portion.

The coil substrate may include a via pattern disposed in a via hole formed through the coil substrate in a thickness direction, and the upper coil and the lower coil may be connected to each other via the via pattern.

The via hole may be disposed in a plurality, and the via hole may be disposed in larger quantity in an area adjacent to the inner leg than in an area adjacent to the outer leg.

The width of each of the plurality of overlapping coil patterns may increase linearly from the inner leg to the outer leg.

The width of each of the plurality of overlapping coil patterns may increase nonlinearly from the inner leg to the outer leg.

The number of turns of the plurality of overlapping coil patterns disposed from the inner leg to a first point may exceed a half of the total number of turns of the plurality of overlapping coil patterns, and the distance between the inner leg and the first point may be a half of the sum of the widths of the plurality of overlapping coil patterns located between the inner leg and the outer leg.

### BRIEF DESCRIPTION OF THE DRAWINGS

Arrangements and embodiments may be described in detail with reference to the following drawings in which like reference numerals refer to like elements and wherein:

FIG. 1 is a coupled perspective view of an inductor according to an embodiment;

FIG. 2 is an exploded perspective view of the inductor according to the embodiment;

FIG. 3 is a plan view of a coil unit according to an embodiment;

FIG. 4 is an enlarged plan view of area A of FIG. 3;

FIGS. 5A and 5B are graphs showing an increase in the width of a coil pattern according to an embodiment;

FIG. 6 is a plan view showing a coil pattern of an inductor according to another embodiment;

FIG. 7 is a plan view and a sectional view showing a coil unit according to a further embodiment;

FIG. 8 is a sectional view of the inductor according to the embodiment; and

FIG. 9 is a graph showing a change in DC-bias based on inductance of the inductor according to the embodiment.

### DESCRIPTION OF SPECIFIC EMBODIMENTS

The present disclosure may be changed in various manners and may have various embodiments, wherein specific embodiments will be described with reference to the drawings. However, the present disclosure is not limited to the specific embodiments, and it should be understood that the present disclosure includes all modifications, equivalents, or substitutions included in the idea and technical scope of the present disclosure.

Although terms including ordinal numbers, such as “first” and “second,” may be used herein to describe various components, these components should not be limited by these terms. These terms are only used to distinguish one component from another component. For example, without departing from the scope of the present disclosure, a second component may be named a first component, and similarly, a first component may be named a second component. The term “and/or” includes any combination of a plurality of related listed items or any one of a plurality of related listed items.

It should be understood that, when a component is referred to as being “connected to” or “coupled to” another component, it may be directly connected to or coupled to another component or intervening components may be present. In contrast, it should be understood that, when a component is referred to as being “directly connected to” or “directly coupled to” another component, there are no intervening components present.

In the following description of the embodiments, it will be understood that, when an element, such as a layer (film), an area, a pattern, or a structure, is referred to as being “on” or “under” another element, such as a substrate, a layer (film), an area, a pad, or a pattern, it can be “directly” on or under another element or can be formed such that an intervening element is also present. The reference to on/above or below/under each layer is described with reference to the drawings. In addition, the thickness or size of each layer (film), area, pattern, or structure in the drawings may be varied for clarity and convenience of description and is not necessarily indicative of actual size.

The terms used in the present application are provided only to described specific embodiments, and do not limit the present disclosure. Singular forms are intended to include plural forms as well, unless the context clearly indicates otherwise. In the present application, it should be understood that the terms “includes,” “has,” etc. specify the presence of stated features, numbers, steps, operations, elements, components, or combinations thereof, but do not preclude the presence or addition of one or more other features, numbers, steps, operations, elements, components, or combinations thereof.

All terms, including technical and scientific terms, have the same meanings as those commonly understood by one of ordinary skill in the art to which this disclosure pertains, unless otherwise defined. Commonly used terms, such as those defined in typical dictionaries, should be interpreted as being consistent with the contextual meaning of the relevant art, and are not to be construed in an ideal or overly formal sense unless expressly defined to the contrary.

Hereinafter, embodiments will be described in detail with reference to the accompanying drawings, wherein identical or corresponding components are given the same reference symbols regardless of drawing designation, and duplicative descriptions thereof will be omitted.

In addition, some embodiments are described using a Cartesian coordinate system (X-axis, Y-axis, Z-axis), and in the Cartesian coordinate system, the X-axis, Y-axis, and Z-axis shown in each figure are orthogonal to each other, but the present disclosure is not limited thereto. The X-axis, Y-axis, and Z-axis may intersect each other. Hereinafter, for convenience of description, the Z-axis direction is referred to as a vertical direction, and each of the X-axis direction and the Y-axis direction is referred to as a horizontal direction. Furthermore, the X-axis direction is referred to as a first direction and the Y-axis direction is referred to as a second direction.

Hereinafter, an inductor according to an embodiment will be described in detail with reference to the accompanying drawings. The inductor according to the embodiment is an example, and the present disclosure is not necessarily limited thereto. The inductor according to the embodiment may be a component of an EMI filter, and may also be implemented as a transformer.

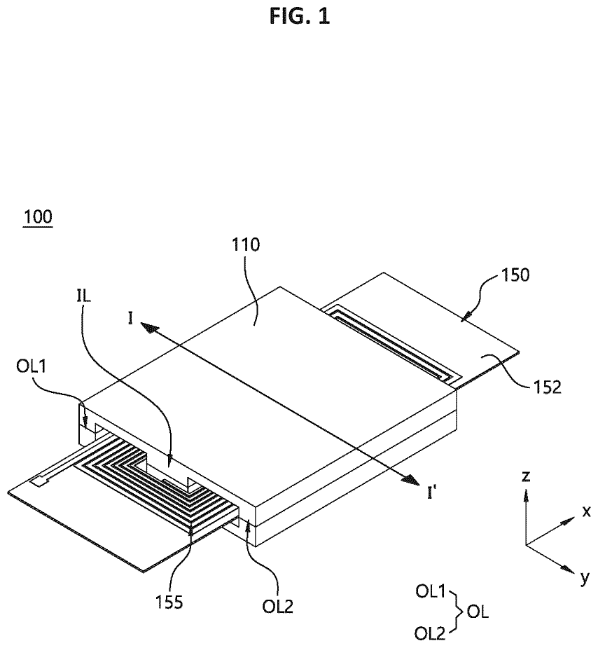

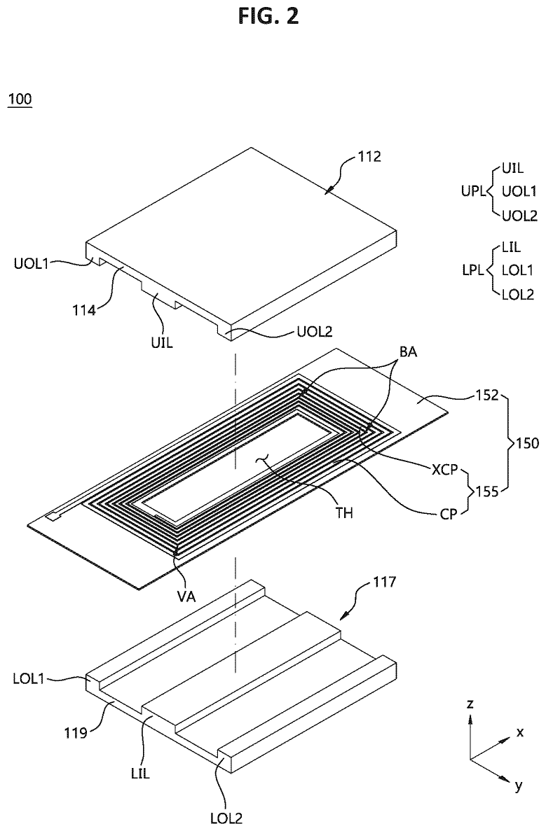

FIG. 1 is a coupled perspective view of an inductor according to an embodiment, and FIG. 2 is an exploded perspective view of the inductor according to the embodiment.

Referring to FIGS. 1 and 2, the inductor 100 according to the embodiment includes a core unit 110 and a coil unit 150. Each component will be described in detail below.

The core unit 110 may be made of a magnetic material and may have the characteristic of a magnetic circuit, acting as a path for magnetic flux. The core unit 110 may include, for example, iron or ferrite, but the present disclosure is not limited thereto.

The core unit 110 includes an inner leg IL and an outer leg OL. The outer leg OL may include a first outer leg portion OL1 disposed on one side and a second outer leg portion OL2 disposed on the other side in a second direction.

The inner leg IL is disposed between the first outer leg portion OL1 and the second outer leg portion OL2. That is, the inner leg IL is formed within the range formed by the first and second outer leg portions OL1 and OL2. The inner leg IL may be disposed in the middle between the first and second outer leg portions OL1 and OL2 in the second direction, and may be disposed spaced apart from the middle. In particular, the inner leg IL disposed in the middle between the first and second outer leg portions OL1 and OL2 may be referred to as a “middle leg.” In the present embodiment, the inner leg IL disposed in the middle between the first and second outer leg portions OL1 and OL2, i.e., the middle leg, will be described by way of example.

The core unit 110 may include an upper core unit 112 located on an upper side and a lower core unit 117 located on a lower side. The upper core unit 112 and the lower core unit 117 may be opposite each other in a vertical direction. The upper core unit 112 and the lower core unit 117 may be symmetrical to each other up and down or may be asymmetrical. Any one of the upper core unit 112 and the lower core unit 117 may be removed. In the following description, the upper core unit 112 and the lower core unit 117 will be described as being symmetrical to each other up and down for convenience of description.

In order to form the inner leg IL and the outer leg OL at the core unit 110, each of the upper core unit 112 and the lower core unit 117, which is coupled to a lower side of the upper core unit 112, may be provided with a plurality of legs.

Specifically, the upper core unit 112 may include a flat upper body portion 114 and an upper leg portion UPL protruding from the upper body portion 114 toward the lower core unit 117.

The upper leg portion UPL may include an upper inner leg portion UIL to form the inner leg IL and a first upper outer leg portion UOL1 and a second upper outer leg portion UOL2 to form the first and second outer leg portions OL1 and OL2, respectively. The first upper outer leg portion UOL1 and the second upper outer leg portion UOL2 may protrude toward the lower core unit 117 and may be spaced apart from each other in the second direction.

The lower core unit 117 may include a flat lower body portion 119 and a lower leg portion LPL protruding from the lower body portion 119 toward the upper core unit 112.

The lower leg portion LPL may include a lower inner leg portion LIL to form the inner leg IL and a first lower outer leg portion LOL1 and a second lower outer leg portion LOL2 to form the first and second outer leg portions OL1 and OL2, respectively. The first lower outer leg portion LOL1 and the second lower outer leg portion LOL2 may protrude toward the first upper outer leg portion UOL1 and the second upper outer leg portion UOL2, respectively, and may be spaced apart from each other in the second direction.

The inner leg IL and an outer leg OL of the inductor 100 may be formed by disposing the lower leg portion UPL and the upper leg portion UPL so as to face each other.

In a specific example, the inner leg IL may be formed by disposing the lower inner leg portion LIL and the upper inner leg portion UIL so as to face each other while being opposite each other. The first outer leg portion OL1 of the outer leg OL may be formed by disposing the first upper outer leg portion UOL1 and the first lower outer leg portion LOL1 so as to face each other while being opposite each other. The second outer leg portion OL2 may be formed by disposing the second upper outer leg portion UOL2 and the second lower outer leg portion LOL2 so as to face each other while being opposite each other.

As such, in the inductor 100 according to the embodiment of the present disclosure, the leg portions of the inner leg IL and the outer leg OL may be disposed opposite each other in pairs.

A gap G of a predetermined distance in the vertical direction may be formed between at least some of outer leg pairs or middle leg pairs opposite each other. For example, the distance in the vertical direction of the gap G may be 10 um to 700 mm; however, the present disclosure is not necessarily limited thereto. Inductance of the core unit 110 may be controlled by adjusting the size of the gap G between one middle leg pair and each of two outer leg pairs, and heat generation may be controlled depending on the number of gaps.

The coil unit 150 may be disposed between the upper core unit 112 and the lower core unit 117. The core unit 110 is disposed so as to wrap around a part of the coil unit 150.

The coil unit 150 may include a coil substrate 152 and a coil 155 disposed on the coil substrate 152. The coil unit 150 may further include a withdrawal portion WP formed integrally with the coil 155 and disposed on one side of the coil substrate 152. The withdrawal portion WP will be described in more detail later. In the present embodiment, the inductor is shown and described as including one coil unit with one coil 155 disposed on one coil substrate 152 for ease of description; however, the present disclosure is not limited thereto, and the inductor may include a plurality of coil units with a coil disposed on each of a plurality of coil substrates.

The coil substrate 152 may include a through-hole TH formed at the position corresponding to the inner leg IL.

The coil 155 may be spirally disposed around the through-holes TH. As the coil 155 is disposed around the through-hole TH, the coil 155 is disposed so as to spirally wrap around the inner leg IL.

The coil 155 is disposed between the inner leg IL and the outer leg OL and has a width in a horizontal direction gradually increasing from the inner leg IL to the outer leg OL.

The coil 155 includes a plurality of overlapping coil patterns CP and a plurality of non-overlapping coil patterns XCP. A conductor constituting a single coil 155 may be divided into a plurality of segments, and for each of the overlapping coil pattern CP and the non-overlapping coil pattern XCP, the coil pattern may refer to each of the plurality of segments.

The plurality of overlapping coil patterns CP may include a coil pattern extending in a first direction, which is one component of the horizontal direction, passing between the inner leg IL and the outer leg OL, and disposed so as to overlap the core unit 110 in the vertical direction, among a plurality of coil patterns. Here, the first direction may be an X-axis direction shown in FIGS. 1 and 2. Consequently, the plurality of overlapping coil patterns CP may be disposed overlapping each other or spaced apart from each other in a Y-axis direction.

The plurality of non-overlapping coil patterns XCP may include a coil pattern extending in a second direction, which is another component of the horizontal direction and intersects the first direction, and disposed so as not to overlap the core unit 110 in the vertical direction, among a plurality of coil patterns. Here, the second direction may be the Y-axis direction shown in FIGS. 1 and 2. Consequently, the plurality of non-overlapping coil patterns XCP may be disposed overlapping each other or spaced apart from each other in the X-axis direction.

In addition, the plurality of non-overlapping coil patterns XCP may include a bent portion BA bent from the plurality of overlapping coil patterns CP in the second direction. The coil 155 may be disposed in a quadrangular shape with four bent portions BA. While the present embodiment shows a quadrangular coil 155 having four bent portions BA, the present disclosure is not limited thereto, and the coil may be disposed in a circular or oval shape.

Any one of the four bent portions BA may include a width variation portion VA where the width of the non-overlapping coil pattern XCP is varied. Since the non-overlapping coil pattern XCP with the changed width at the width variation portion VA extends to the overlapping coil pattern CP, the non-overlapping coil pattern XCP and the overlapping coil pattern CP are alternately disposed in a turn pattern forming one turn. In the turn pattern forming one turn, therefore, the number of overlapping coil patterns CP and the number of non-overlapping coil patterns XCP may be the same.

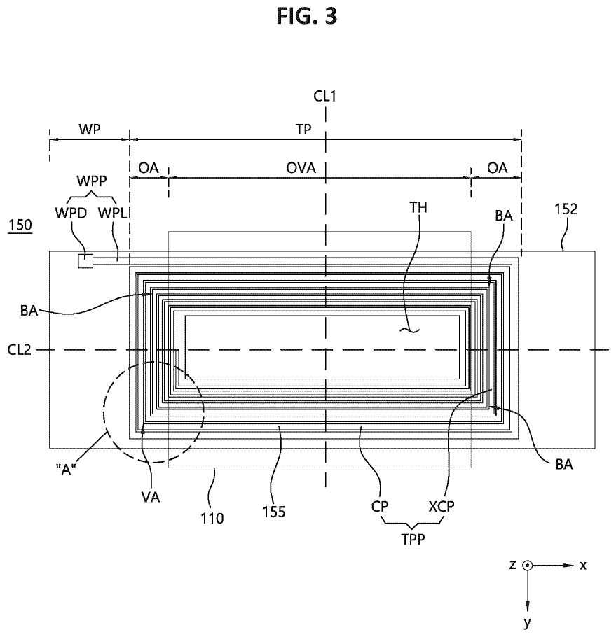

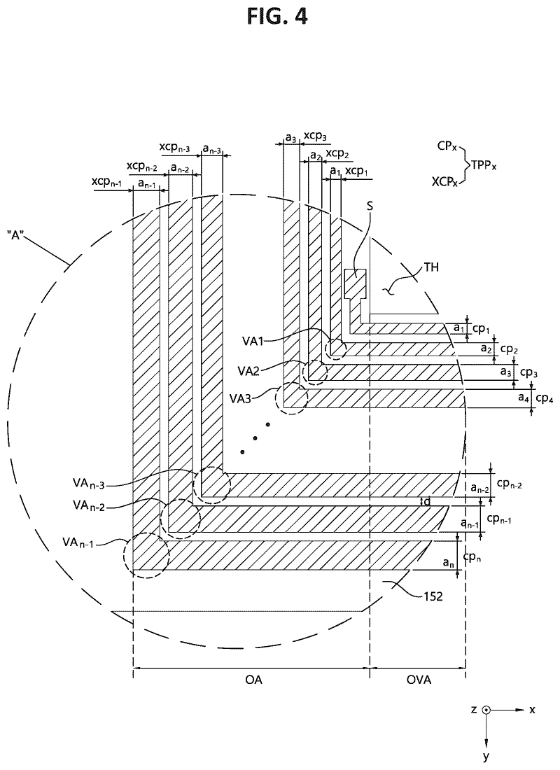

The non-overlapping coil pattern XCP and the overlapping coil pattern CP will be described in more detail with reference to FIGS. 3 and 4.

FIG. 3 is a plan view of a coil unit according to an embodiment, and FIG. 4 is an enlarged plan view of area A of FIG. 3.

Referring to FIGS. 1 to 4, the coil unit 150 may include a turn portion TP in which the coil 155 is disposed while having a predetermined number of turns, and a withdrawal portion WP in which a part of the coil 155 extends from the turn portion TP.

The turn portion TP includes an overlap area OVA where the coil 155 overlaps the core unit 110 in the vertical direction and a non-overlap area OA where the coil 155 does not overlap the core unit 110 in the vertical direction.

The coil 155 disposed on the turn portion TP may include an overlapping coil pattern CP disposed on the overlap area OVA and having different widths and a non-overlapping coil pattern XCP disposed on the non-overlap area OA.

The overlapping coil pattern CP may include a plurality of patterns extending on the overlap area OVA where the coil 155 overlaps the core unit 110 in the vertical direction, i.e., between the inner leg IL and the outer leg OL, in the first direction (X-axis direction), having different widths in the second direction (Y-axis direction), and overlapping each other while being spaced apart from each other in the second direction.

For example, the plurality of overlapping coil patterns CP may include a coil pattern adjacent to the inner leg IL and a coil pattern adjacent to the outer leg OL.

First, as the overlapping coil pattern adjacent to the inner leg IL, the overlapping coil pattern CP may include a first overlapping coil pattern CP1 disposed around the through-hole TH, i.e., closest to the inner leg IL inserted into the through-hole TH, and having a first width a1, a second overlapping coil pattern CP2 spaced apart from the first overlapping coil pattern CP1 in the Y-axis direction by a predetermined distance and having a second width a2 greater than the first width a1, a third overlapping coil pattern CP3 spaced apart from the second overlapping coil pattern CP2 in the Y-axis direction by a predetermined distance and having a third width a3 greater than the second width a2, and a fourth overlapping coil pattern CP4 spaced apart from the third overlapping coil pattern CP3 in the Y-axis direction by a predetermined distance and having a fourth width a4 greater than the third width a3.

Next, as the overlapping coil pattern adjacent to the outer leg OL, the overlapping coil pattern CP may include an N-th overlapping coil pattern CPn closest to the outer leg OL and disposed in an N-th width an. Consequently, the overlapping coil pattern CP disposed on the overlap area OVA in the coil unit 150 may include first to N-th overlapping coil patterns CP1 to CPn disposed above and below the through-hole TH in the Y-axis direction.

The plurality of non-overlapping coil patterns XCP may include a part extending in the first direction from the overlapping coil pattern CP that has passed through the overlap area OVA in the first direction (X-axis direction) on the non-overlap area OA where the coil 155 does not overlap the core unit 110 in the vertical direction. The non-overlapping coil pattern XCP may include a plurality of patterns bent and extending in the first direction (X-axis direction) to the second direction (Y-axis direction), having different widths in the first direction (X-axis direction), and overlapping each other while being spaced apart from each other in the first direction.

For example, the non-overlapping coil pattern XCP may include a first non-overlapping coil pattern XCP1 disposed around the through-hole TH, i.e., closest to the inner leg IL inserted into the through-hole TH, and having a first width a1, a second non-overlapping coil pattern XCP2 spaced apart from the first non-overlapping coil pattern XCP1 in the X-axis direction by a predetermined distance and having a second width a2 greater than the first width a1, a third non-overlapping coil pattern XCP3 spaced apart from the second non-overlapping coil pattern XCP2 in the X-axis direction by a predetermined distance and having a third width a3 greater than the second width a2, a fourth non-overlapping coil pattern XCP4 spaced apart from the third non-overlapping coil pattern XCP3 in the X-axis direction by a predetermined distance and having a fourth width a4 greater than the third width a3, and an N-th non-overlapping coil pattern XCPn disposed farthest from the inner leg IL in the X-axis direction and having an N-th width an.

Consequently, the non-overlapping coil pattern XCP disposed on the non-overlap area OA in the coil unit 150 may include first to N-th non-overlapping coil patterns XCP1 to XCPn disposed on the left and right sides of the through-hole TH in the X-axis direction.

The non-overlap area OA is defined in the state in which in which ends of the body portions 114 and 119 disposed opposite each other in the first direction and ends of the through-hole TH disposed opposite each other in the first direction are disposed so as to overlap each other in the vertical direction; however, the present disclosure is not limited thereto.

In another embodiment, the non-overlap area may be defined in the state in which ends of the body portions 114 and 119 disposed opposite each other in the first direction and ends of the first non-overlapping coil pattern XCP1 located opposite each other in the first direction and having the first width a1 are disposed so as to overlap each other in the vertical direction. In this case, the second non-overlapping coil pattern XCP2 having the second width a2, which is one of the non-overlapping coil patterns XCP, may be a non-overlapping coil pattern XCP closest to the IL.

Meanwhile, the plurality of non-overlapping coil patterns XCP may include a bent portion BA bent from the first direction to the second direction. The coil 155 may be disposed in a quadrangular shape with four bent portions BA. While the present embodiment shows a quadrangular coil 155 having four bent portions BA, the present disclosure is not limited thereto.

Any one of the four bent portions BA may include a width variation portion VA where the width of the non-overlapping coil pattern XCP is varied. The width variation portion VA is a part having different widths, and is a point where the width changes from the width of one side connected to the overlapping coil pattern CP to the width of the other side.

Here, the pattern in which the non-overlapping coil pattern XCP and the overlapping coil pattern CP of the same width starting from the width variation portion VA are turned on the inner leg IL once is collectively defined as a “turn pattern TPP.”

In the drawings, each of a plurality of turn patterns TPPx is shown as including a pair of non-overlapping coil patterns XCPx passing through the through-hole TH and opposite each other in the first direction with respect to an imaginary first reference line CL1 parallel to the second direction and a pair of overlapping coil patterns CPx passing through the through-hole TH and opposite to each other in the second direction with respect to a second reference line CL2 parallel to the first direction, where x is a positive integer, 1≤x≤N.

As such, the turn portion TP may include a plurality of non-overlapping coil patterns XCP disposed in the non-overlap area OA and a plurality of overlapping coil patterns CP disposed on the overlap area OVA. The turn portion TP may include N turn patterns TPP having different widths around the width variation portion VA.

For example, among the plurality of turn patterns TPP, a first turn pattern TPP1 may be formed with a first width a1 from a start point S disposed on the overlap area OVA to an end point, which is a first width variation portion VA1 disposed on the non-overlap area OA.

Among the plurality of turn patterns TPP, a second turn pattern TPP2 may be integrally formed with the first turn pattern TPP1. The second turn pattern TPP2 may have a second width a2 greater than the first width a1. The second turn pattern TPP2 having the second width a2 may be disposed from a start point, which is the first width variation portion VA1, to an end point, which is a second width variation portion VA2, while extending to the second non-overlapping coil pattern XCP2 of the non-overlap area OA through the second overlapping coil pattern CP2 of the overlap area OVA.

In addition, a third turn pattern TPP3 may be integrally formed with the second turn pattern TPP2, and may have a third width a3 greater than the second width a2. The third turn pattern TPP3 having the third width a3 may be disposed from a start point, which is the second width variation portion VA2, to an end point, which is a third width variation portion VA3, while extending to the third non-overlapping coil pattern XCP3 of the non-overlap area OA through the third overlapping coil pattern CP3 of the overlap area OVA.

A fourth turn pattern TPP4 to an (N−1)-th turn pattern TPPn−1 may be disposed in the same manner as described above.

An N-th turn pattern TPPn closest to the outer leg OL may have an N-th width an greater than the (N−1)-th width an−1, and may be disposed from a start point, which is an (N−1)-th width variation portion VAn−1, to the withdrawal portion WP. As such, the turn patterns TPP may include first to N-th turn patterns TPP1 to TPPn disposed on the turn portion TP.

In the inductor 100 according to the embodiment, a part of the bent portion BA may be formed as the width variation portion VA, whereby it is possible to maintain the distance d between the turn patterns TPP1 to TPPn constant although the width of the turn patterns TPP is changed.

Meanwhile, the withdrawal portion WP extends from the N-th turn pattern TPPn and is an area where the withdrawal pattern WPP is disposed.

The withdrawal pattern WPP includes a withdrawal line WPL integrally formed with the N-th turn pattern TPPn and extending to the withdrawal portion WP and a withdrawal pad WPD disposed at the end of the withdrawal line WPL.

The withdrawal line WPL may have the same width as the N-th turn pattern TPPn, since the withdrawal line extends from the N-th turn pattern TPPn having the n-th width an. However, the present disclosure is not limited thereto, and the withdrawal line may have a different width than the N-th turn pattern TPPn depending on the circumstances. The withdrawal pad (WPD) may have a larger width than the withdrawal line WPL.

As such, in the inductor 100 according to the embodiment, the width of the overlapping coil pattern CP is gradually increased from the inner leg IL to the outer leg OL in a limited space, thereby increasing the number of turns of the overlapping coil pattern CP of the inductor 100. As the number of turns is increased, inductance increases, which may improve DC-bias performance, and the overall resistance of the inductor 100 may be reduced by increasing the width of the outermost N-th coil pattern CPn, which has the greatest resistance, whereby it is possible to minimize heat generation.

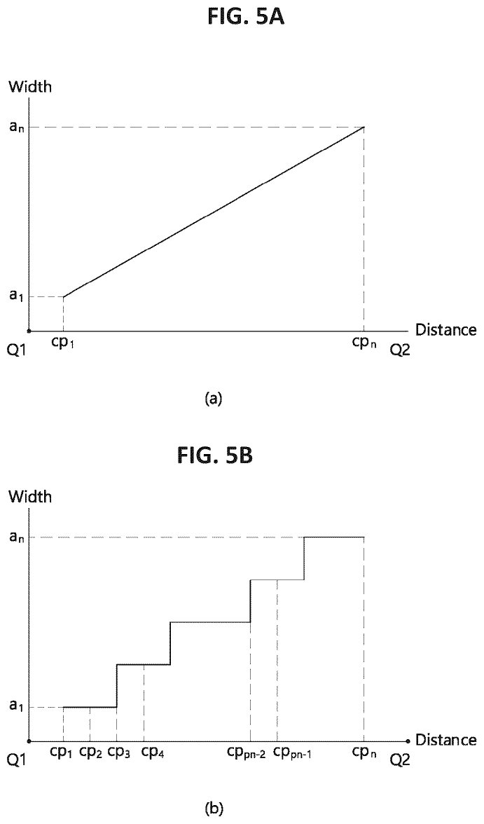

FIGS. 5A and 5B are graphs showing an increase in the width of a coil pattern according to an embodiment.

FIG. 5A is a graph showing a linear increase in the width of the overlapping coil pattern CP, and FIG. 5B is a graph showing a nonlinear increase in the width of the overlapping coil pattern CP. Here, the width of the overlapping coil pattern CP is determined by the width of the turn pattern TPP, and therefore a description will be given based on the turn pattern TPP.

Here, Q1 in the graph refers to the center of the inner leg IL, and Q2 refers to the center of the outer leg OL. That is, Q1 may represent the position of the center of the inner leg IL on the Y axis, and Q2 may represent the position of the center of the outer leg OL on the Y axis. Here, the outer leg OL refers to the first outer leg portion OL1 or the second outer leg portion OL2. In other words, the overlapping coil patterns CP disposed on the inner leg IL and the first outer leg portion OL 1 or the inner leg IL and the second outer leg portion OL2 are disposed so as to be symmetrical to each other, either of which will be described for ease of understanding.

FIG. 5A is a graph showing the case of FIG. 4. As described above, the width of the turn pattern TPP may be disposed such that the width a of the overlapping coil pattern CP and the width a of the non-overlapping coil pattern XCP increase linearly from the center of the inner leg IL to the outer leg OL. Specifically, the width of the turn pattern TPP may be formed such that the width of the overlapping coil pattern CP and the width of the non-overlapping coil pattern XCP increase linearly for each turn around the width variation portion VA.

In FIG. 5B, the width a of the turn pattern TPP is gradually increased from the inner leg IL to the outer leg OL, but optionally, the width a of the turn pattern TPP may be disposed such that the width a of the turn pattern TPP is uniform in a specific section, and the width a of the turn pattern TPP is increased again after the specific section. That is, the width of the turn pattern TPP may be formed such that the width of the overlapping coil pattern CP and the width of the non-overlapping coil pattern XCP increase nonlinearly for each turn around the width variation portion VA.

In FIG. 5A and FIG. 5B, the turn patterns TPP may be disposed such that the width between neighboring turn patterns TPP has an increase rate of 5% to 15%. Consequently, the width by which each of the plurality of overlapping coil patterns CP increases in the horizontal direction (Y-axis direction) may be 5% to 15%.

The case in which the increase rate of the width of the turn pattern TPP corresponds to 10% according to FIG. 5A will be described by way of example. When the width a1 of the first turn pattern TPP1 is 1.5 mm, the width a2 of the second turn pattern TPP2 from the first width variation portion VA1 may be increased to 1.65 mm in the Y-axis direction. Therefore, the width a2 of the second overlapping coil pattern CP2 of the second turn pattern TPP2 disposed on the overlap area OVA may be 1.65 mm.

The third turn pattern TPP3 may have a width of 1.815 mm increased in the Y-axis direction from the second width variation portion VA2. Therefore, the width a3 of the third overlapping coil pattern CP3 of the third turn pattern TPP3 disposed on the overlap area OVA may be 1.815 mm.

The fourth turn pattern TPP4 may have a width of 1.9965 mm, i.e., approximately 2 mm, from the third width variation portion VA3. Therefore, the width a4 of the fourth coil pattern CP4 of the fourth turn pattern TPP4 disposed on the overlap area OVA may be 2 mm.

The case in which the increase rate of the width of the coil pattern corresponds to 10% according to FIG. 5B, will be described by way of example. When the turn pattern TPP having the same width is disposed in a specific section and then the turn pattern TPP is increased again, a turn pattern TPP having a width 10% greater than the width a of the previous turn pattern TPP may be disposed.

Consequently, the overlapping coil patterns CP disposed on the overlap area OVA, among the turn patterns TPP, may include a plurality of overlapping coil patterns CP having the same width in a specific section and overlapping coil patterns CP that increase in width, whereby the width of the overlapping coil patterns CP may have a nonlinearly increasing rate.

As such, in the inductor 100 according to the embodiment, the width of the overlapping coil pattern CP may be gradually increased from the inner leg IL to the outer leg OL in a limited space, thereby increasing the number of turns of the overlapping coil pattern CPs of the inductor 100. When the number of turns increases, inductance increases, which may improve DC-bias performance, and the overall resistance of the inductor 100 may be reduced by increasing the width of the outermost N-th coil pattern CPn, which has the greatest resistance, whereby it is possible to minimize heat generation.

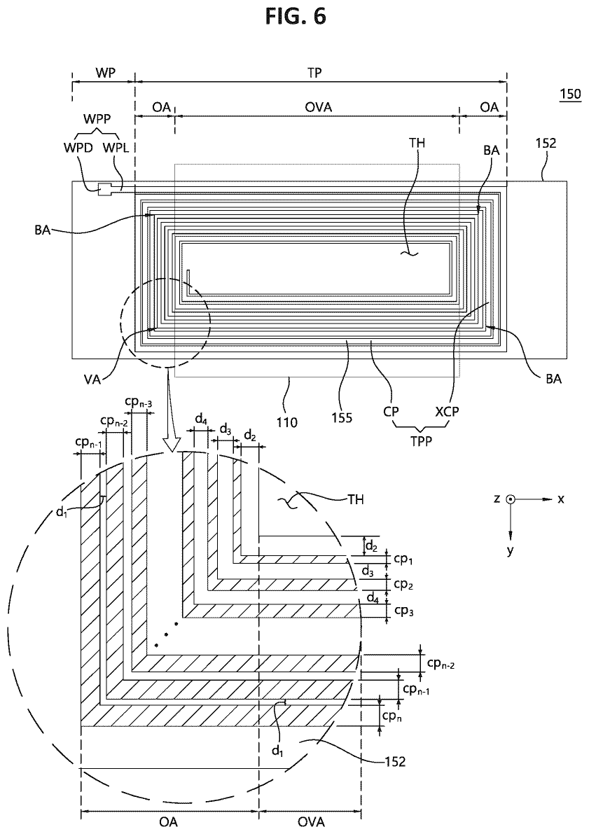

FIG. 6 is a plan view showing a coil pattern of an inductor according to another embodiment.

In order to avoid a duplicative description and for ease of description, FIGS. 1 to 4 will be cited when describing FIG. 6.

Referring to FIG. 6, the inductor according to the other embodiment has a coil unit 110 having a different distance from the inductor 100 according to the embodiment.

The coil unit 110 includes a plurality of turn patterns TPP disposed on the turn portion TP, and the turn patterns TPP include overlapping coil patterns CP disposed on the overlap area OVA and non-overlapping coil patterns XCP disposed on the non-overlap area OA.

The plurality of overlapping coil patterns CP adjacent to each other on the overlap area OVA may be spaced apart from each other by a first distance d1, which is uniform. The first distance d1 may be the same as the distance d in FIG. 3.

The plurality of non-overlapping coil patterns XCP adjacent to each other on the non-overlap area OA may be spaced apart from each other by different distances.

For example, an (n−1)-th non-overlapping coil pattern XCPn−1 and an n-th non-overlapping coil pattern XCPn closest to the outer leg OL on the non-overlap area OA may be spaced apart from each other by an n-th distance dn. The n-th distance dn may be the same as the first distance d1. An (n−2)-th non-overlapping coil pattern XCPn−2 and the (n−1)-th non-overlapping coil pattern XCPn−1 may be spaced apart from each other by an (n−1)-th distance dn−1.

Here, each of the n-th distance dn and the (n−1)-th distance dn−1 may have an increase rate of 5% to 15% proportional to the increase rate of the width of the non-overlapping coil pattern XCP.

As a result, a second non-overlapping coil pattern XCP2 and a third non-overlapping coil pattern XCP3 adjacent to the inner leg IL may be spaced apart from each other by a third distance d3, and a first non-overlapping coil pattern XCP1 and the second non-overlapping coil pattern XCP2 may be spaced apart from each other by a second distance d2. Here, the third distance d3 may have an increase rate of 5% to 15% in proportion to the increase rate of the second distance d2.

The distance may increase gradually from the outer leg OL to the inner leg IL such that the distance closest to the inner leg IL is the greatest.

As such, the distance between the plurality of non-overlapping coil patterns XCP on the non-overlap area OA may be changed such that the distance between the non-overlapping coil patterns XCP gradually increases toward the inner leg IL, thereby facilitating the manufacturing process of the turn pattern TPP in the non-overlap area OA and facilitating the installation of additional structures.

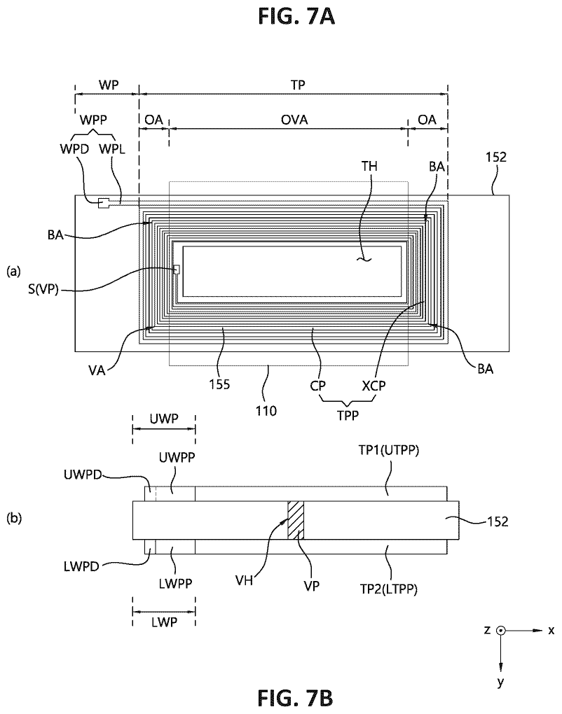

FIGS. 7(a) and 7(b) are, respectively, a plan view and a sectional view of a coil unit according to a further embodiment.

In order to avoid a duplicative description and for ease of description, FIGS. 1 to 4 will be cited when describing FIG. 7.

The coil unit 150 according to the further embodiment may include a turn portion TP (hereinafter referred to as a “first turn portion TP1”) disposed on one surface of a core substrate 152 and a turn portion TP (hereinafter referred to as a “second turn portion TP2”) disposed on the other surface of the core substrate, which is opposite the one surface in a vertical direction.

A turn pattern TPP disposed on the turn portion TP and the relationship between a coil pattern CP and a non-coil pattern XCP included in the turn pattern TPP have been described above, and therefore a description thereof will be omitted.

The first turn portion TP1 is an upper coil disposed on an upper surface of the core substrate 152, and includes a plurality of upper turn patterns UTPP spirally disposed around an upper inner leg portion UIL.

The second turn portion TP2 is a lower coil disposed on a lower surface of the core substrate, which is opposite the upper surface, and spirally disposed around a lower inner leg portion LIL, and includes a plurality of lower turn patterns LTPP.

In addition, a withdrawal portion WP is disposed at each of an upper part and a lower part of the coil substrate 152. In order to distinguish between the withdrawal portions WP, the withdrawal portions WP will be referred to as an upper withdrawal portion UWP disposed above and a lower withdrawal portion LWP disposed below.

An upper withdrawal line UWPL and an upper withdrawal pad UWPD may be disposed at the upper withdrawal portion UWP, and a lower withdrawal line LWPL and a lower withdrawal pad LWPD may be disposed at the lower withdrawal portion LWP.

The first turn portion TP1 and the second turn portion TP2 may be connected to each other via a via pattern VP.

In order to connect the first turn portion TP1 and the second turn portion TP2 to each other, a via hole VH may be formed through a part of the coil substrate 152 in a thickness direction. The via pattern VP connected to the first turn portion TP1 and the second turn portion TP2 while filling the via hole VH may be buried in the via hole VH. Consequently, the first turn portion TP1 and the second turn portion TP2 may be electrically connected to each other via the via pattern VP.

In the present embodiment, forming the via pattern VP at a point corresponding to a start point S of each of the first turn portion TP1 and the second turn portion TP2 will be described by way of example; however, the present disclosure is not limited thereto.

For example, several via holes VH may be further provided at the non-overlapping coil pattern XCP adjacent to the inner leg IL. Since the current density at the periphery of the inner leg IL enclosed by the core unit 110 is higher than the current density at the periphery of the outer leg OL and an increase in current density causes an increase in resistance, relatively many via holes VH are disposed adjacent to the inner leg IL to reduce the resistance value. In another example, the via holes VH and the via patterns VP may be disposed so as to cluster in the overlap area OVA or the non-overlap area OA to reduce the resistance value of the turn pattern.

As such, the inductance of the inductor 100 may be increased and the DC-bias performance may be improved by disposing the overlapping coil patterns CP above and below a single coil substrate 152, respectively.

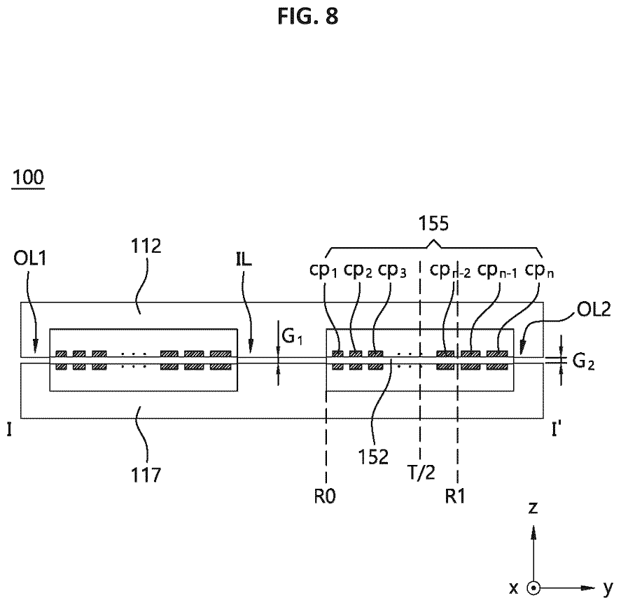

FIG. 8 is a sectional view of the inductor according to the embodiment.

FIG. 8 is a sectional view taken along line I-I′ of FIG. 1. In order to avoid a duplicative description and for ease of description, FIGS. 1 to 5 will be cited when describing FIG. 8.

Referring to FIG. 8, in the inductor 100 according to the embodiment, the number of turns of the plurality of overlapping coil patterns CP disposed from the inner leg IL (R0) to a first point R1 exceeds half of the total number of turns T of the plurality of overlapping coil patterns CP. The distance between the inner leg IL (R0) and the first point R1 is half of the sum of the widths of the plurality of overlapping coil patterns CP located between the inner leg IL and the outer leg OL. This is represented by Equation 1.

$$\frac{1}{2} {\sum }_{k = 1}^{n} {a}_{k} ≻ \frac{T}{2} \qquad [ Equation 1 ]$$

where k of ak is the width of the coil pattern (1≤k≤n), and T is the total number of turns.

Specifically, the number of turns may be increased by disposing the plurality of overlapping coil patterns CP in a given area. That is, inductance may increase. Since inductance is proportional to the square of the number of turns and increases with the sectional size of the inner leg IL, the inductance may be increased by increasing the square of the number of turns in a defined space.

Furthermore, DC-bias performance may be improved by forming at least one of a first gap G1 formed between the upper inner leg portion UIL and the lower inner leg portion LIL or a second gap G2 formed between the upper outer leg portion UOL and the lower outer leg portion UOL.

In the inductor 100 according to the embodiment, therefore, the number of turns of the overlapping coil pattern CP of the inductor 100 may be increased by gradually increasing the width of the overlapping coil pattern CP from the inner leg IL to the outer leg OL in a limited space. When the number of turns is increased, inductance increases, which may improve DC-bias performance, and the overall resistance of the inductor 100 may be reduced by increasing the width of the outermost N-th coil pattern CPn, which has the greatest resistance, whereby it is possible to minimize heat generation.

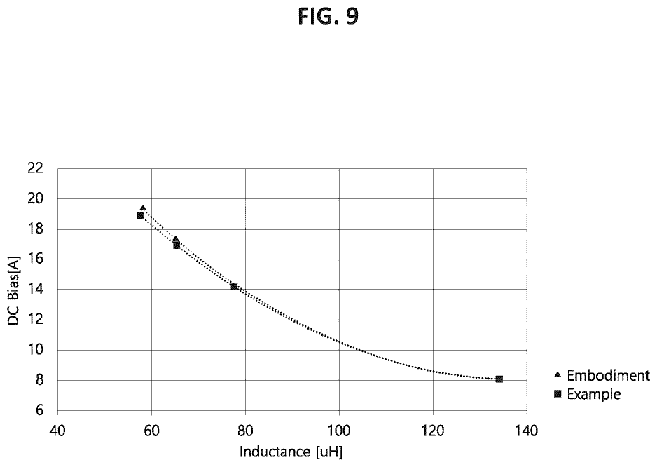

FIG. 9 is a graph showing a change in DC-bias based on inductance of the inductor according to the embodiment.

In order to avoid a duplicative description and for ease of description, FIGS. 1 to 4 and 8 will be cited when describing FIG. 9.

Referring to FIG. 9, the inductor according to the embodiment was compared to an inductor according to a comparative example having a coil pattern of the same width.

Each of the inductors according to the embodiment and the comparative example was configured such that a coil pattern of 6 turns is disposed on each of the upper and lower parts of the coil substrate, whereby the total number of turns is 12.

In the comparative example, the width of the overlapping coil patterns CP was 2 mm, and the embodiment was configured to have a first overlapping coil pattern CP1 to a sixth overlapping coil pattern CP6, as shown in FIG. 4. Here, the overlapping coil pattern CP of the embodiment was configured such that the first overlapping coil pattern CP1 had a width of 1.5 mm, the second overlapping coil pattern CP2 had a width of 1.65 mm, which is 10% greater than the width of the first overlapping coil pattern CP1, the third overlapping coil pattern CP3 had a width of 1.82 mm, the fourth overlapping coil pattern CP4 had a width of 2.0 mm, the fifth overlapping coil pattern CP5 had a width of 2.2 mm, and the sixth overlapping coil pattern CP6 had a width of 2.42 mm.

Table 1 below shows the measured values of inductance and DC-bias of the comparative example and the embodiment depending on a change in gap amount. Here, the gap is the gap amount G2 of the outer leg OL. FIG. 9 is a graph showing the amount of change of Table 1.

TABLE 1

| | | | Gap amount |
|---|---|---|---|
| | Inductance | DC-bias | (outer |
| | [uH] | [A] | leg)[mm] |
| Comparative example | 134.7 | 8.1 | 200 |
| (equal width of coil pattern) | 78.4 | 14.2 | 450 |
| | 65.1 | 16.7 | 600 |
| | 57.3 | 19.1 | 700 |
| Embodiment (different widths of | 135.3 | 8.1 | 200 |
| coil pattern) | 79.2 | 14.2 | 450 |
| | 65.05 | 17 | 610 |
| | 58.08 | 19.4 | 700 |

The inductance is found to be more increased in the embodiment than in the comparative example. The reason is as follows.

Since the total number of turns T and the sectional area of the inner leg IL of the comparative example are equal to the total number of turns T and the sectional area of the inner leg IL of the embodiment, the only factor that changes the inductance is the length of a magnetic field. Since the length of the magnetic field is inversely proportional to the inductance, a smaller magnetic field may further increase the inductance. Specifically, in the comparative example, six coil patterns each having a width of 2 mm are provided, whereby the length of the magnetic field length is 12 mm. In other words, the comparative example has a magnetic field length of 12 mm from the inner leg in the Y-axis direction.

In the embodiment, on the other hand, six coil patterns having widths of 1.5 mm to 2.42 mm are provided, whereby the sum of the widths is 11.59 mm. In other words, the embodiment has a magnetic field length of 11.59 mm from the inner leg IL in the Y-axis direction. Therefore, the embodiment has a shorter magnetic field length than the comparative example, resulting in an overall increase in inductance.

There is no difference in DC-bias until the gap amount is 450 mm, but the DC-bias increases when the gap amount is 610 mm or more.

Therefore, if the comparative example and the embodiment are assumed to be the same size, the lengths of the magnetic field are the same in the same space, whereby the inductance increases with increase in the total number of turns, and the DC-bias performance may be improved by adjusting the gap amount in the increased inductance.

As is apparent from the above description, in an inductor according to an embodiment, the width of a coil pattern in a predetermined limited space is controlled to increase the number of turns of the coil pattern, whereby inductance is increased, and therefore it is possible to improve DC-bias performance.

Also, in the inductor according to the embodiment, the width of the outermost coil pattern, which has large resistance, is controlled to reduce overall resistance, whereby it is possible to minimize heat generation.

The effects of the present disclosure are not limited to those described above, and other unmentioned effects will be apparent to those skilled in the art from the above description of exemplary embodiments.

Although the above has been described based on the embodiments, these are merely illustrative and do not limit the present disclosure, and those skilled in the art will recognize that various modifications and applications not illustrated herein are possible without departing from the essential features of the present embodiments. For example, each of the components specifically shown in the embodiments may be practiced with variations. The differences with respect to such variations and applications are to be construed as being within the scope of the present disclosure as defined by the appended claims.

1. An inductor comprising:
a core unit comprising an inner leg and an outer leg; and
a coil unit comprising a coil disposed spirally around the inner leg and a coil substrate on which the coil is disposed, wherein
the coil has a width gradually increasing from the inner leg to the outer leg in a horizontal direction between the inner leg and the outer leg.

2. The inductor according to claim 1, wherein
the coil comprises:
a plurality of overlapping coil patterns extending in a first direction, which is one component of the horizontal direction, passing between the inner leg and the outer leg, and overlapping the core unit in a vertical direction; and
a plurality of non-overlapping coil patterns extending in a second direction, which is another component of the horizontal direction and intersects the first direction, and not overlapping the core unit in the vertical direction,
wherein the plurality of non-overlapping coil patterns comprises a bent portion bent from the first direction to the second direction, and
wherein the bent portion comprises a width variation portion where a width of each of the plurality of non-overlapping coil patterns is varied.

3. The inductor according to claim 1, wherein
the core unit comprises an upper core unit and a lower core unit opposite each other in a vertical direction,
the upper core unit comprises an upper inner leg portion and an upper outer leg portion protruding toward the lower core unit, the upper inner leg portion and the upper outer leg portion being spaced apart from each other in the second direction, and
the lower core unit comprises a lower inner leg portion and a lower outer leg portion protruding toward the upper inner leg portion and the upper outer leg portion, respectively, the lower inner leg portion and the lower outer leg portion being opposite each other and spaced apart from each other in the second direction.

4. The inductor according to claim 3, wherein
the upper outer leg portion comprises a first upper outer leg portion and a second upper outer leg portion disposed at an edge of the upper core unit,
the upper inner leg portion comprises an upper middle leg portion disposed in a middle between the first upper outer leg portion and the second upper outer leg portion,
the lower outer leg portion comprises a first lower outer leg portion and a second lower outer leg portion disposed at an edge of the lower core unit, the first lower outer leg portion and the second lower outer leg portion being opposite the first upper outer leg portion and the second upper outer leg portion, respectively, in the vertical direction, and
the lower inner leg portion comprises a lower middle leg portion disposed in a middle between the first lower outer leg portion and the second lower outer leg portion, the lower middle leg portion being opposite the upper middle leg portion in the vertical direction.

5. The inductor according to claim 4, comprising at least one of a first gap formed between the upper inner leg portion and the lower inner leg portion and a second gap formed between the upper outer leg portion and the lower outer leg portion.

6. The inductor according to claim 3, wherein the coil comprises:
an upper coil disposed on an upper surface of the coil substrate, the upper coil spirally disposed around the upper inner leg portion; and
a lower coil disposed on a lower surface of the coil substrate, the lower coil spirally disposed around the lower inner leg portion.

7. The inductor according to claim 6, wherein
the coil substrate comprises a via pattern disposed in a via hole formed through the coil substrate in a thickness direction, and
the upper coil and the lower coil are connected to each other via the via pattern.

8. The inductor according to claim 2, wherein the width of each of the plurality of overlapping coil patterns increases linearly from the inner leg to the outer leg.

9. The inductor according to claim 2, wherein
the width of each of the plurality of overlapping coil patterns increases nonlinearly from the inner leg to the outer leg.

10. The inductor according to claim 2, wherein
a number of turns of the plurality of overlapping coil patterns disposed from the inner leg to a first point exceeds a half of a total number of turns of the plurality of overlapping coil patterns, and
A distance between the inner leg and the first point is a half of a sum of the widths of the plurality of overlapping coil patterns located between the inner leg and the outer leg.
